(19) United States
(12) Patent Application Publication
(10) Pub. No.: US 2022/0185982 A1
(43) Pub. Date: Jun. 16, 2022

(54) FLAME-RETARDANT FOAMED OBJECT AND FOAM MEMBER

(71) Applicant: NITTO DENKO CORPORATION, Ibaraki-shi, Osaka (JP)

(72) Inventors: Kiyoaki KODAMA, lbaraki-shi (JP); Makoto SAITO, Ibaraki-shi (JP)

(73) Assignee: NITTO DENKO CORPORATION, Ibaraki-shi, Osaka (JP)

(21) Appl. No.: 17/600,217

(22) PCT Filed: Feb. 19, 2020
(86) PCT No.: PCT/JP2020/006471

§ 371 Date: Sep. 30, 2021

(30) Foreign Application Priority Data
Apr. 10, 2019 (JP) 2019-074692

(51) Int. Cl. C08J 9/12; C08L 23/10; C09J 7/26; C09J 7/38

(52) U.S. Cl. CPC C08J 9/122; C08L 23/10; C09J 7/26; C09J 7/385; C08J 2203/06; C09J 2423/106; C09J 2433/00; C08J 2205/044; C08L 2205/03

(57) ABSTRACT

Provided is a flame-retardant foam which has high flame retardancy, is excellent in flexibility, and is excellent in stress dispersibility. Also provided is a foam member including such flame-retardant foam as a flame-retardant foam layer. The flame-retardant foam of the present invention has an apparent density of from 0.02 g/cm³ to 0.40 g/cm³, a 50% compression load of from 0.5 N/cm² to 8.0 N/cm², and a rupture elongation in a tensile test of 120% or less.

### TECHNICAL FIELD

The present invention relates to a flame-retardant foam and a foam member.

### BACKGROUND ART

In recent years, the size of a clearance in a portion in which a resin foam or a foam member is used has been changed, and there has been a demand for a material adaptable to a smaller clearance.

The resin foam or the foam member is used in order to protect a screen, a substrate, and the like of an electronic device. In recent years, electronic devices such as a smartphone and a notebook computer have been increasingly used not only indoors but also during outdoor movement. As a result, an unexpected load is liable to be applied due to the fall of the device or the external application of a pressure. Accordingly, when such load can be effectively dispersed in stress, the electronic device can be prevented from being broken by the unexpected load.

For the above-mentioned reason, there is an increasing demand for a resin foam and a foam member which are excellent in flexibility and adaptable to a smaller clearance, and which have stress dispersibility at a higher level.

Herein, the resin foam contains a thermoplastic polymer, and hence has a problem in that the resin foam is liable to be burnt. Heating elements such as batteries and various elements are adopted in electronic devices such as a smartphone and a notebook computer, and there is a risk of ignition. Thus, it is indispensable to impart flame retardancy.

Hitherto, in order to impart flame retardancy, various flame retardants have been blended. As such flame retardants, for example, a bromine-based resin, a chlorine-based resin, a phosphorus-based compound, an antimony-based compound, and the like are used. However, there is a demand for avoiding the adoption of those flame retardants because of the handleability, the influence on environment, and the like. In recent years, flame retardants that do not contain those compounds have been investigated. As such flame retardants, metal hydroxides such as magnesium hydroxide and aluminum hydroxide are adopted. However, the flame retardants using those metal hydroxides have problems in that the flame retardants are inferior in flame retardancy to conventional flame retardants such as a bromine-based resin, a chlorine-based resin, a phosphorus-based compound, and an antimony-based compound, and are inferior in moldability because a large blending amount is required in order to impart flame retardancy equivalent to the conventional flame retardancy.

In recent years, as a method of obtaining a foam having a fine cell structure, there has been proposed a method involving dissolving an inert gas in a polymer under high pressure and then abruptly decreasing the pressure to form a foam structure. For example, in Patent Literature 1, there is disclosed a method involving loading a thermoplastic polymer into a pressure vessel, loading a high-pressure gas into the pressure vessel while heating the polymer to its softening point, and then decreasing the pressure to form cells.

However, although the foam described in Patent Literature 1 is a foam that is flexible to some extent, the foam does not have flame retardancy, and there is no disclosure or suggestion regarding stress dispersibility.

In Patent Literature 2, there is disclosed a method of obtaining a resin foam excellent in flame retardancy and flexibility with a high foam expansion rate through use of a metal hydroxide to be used as a flame retardant having a small environmental load in combination with carbon black.

However, the resin foam described in Patent Literature 2 cannot exhibit sufficient flexibility, and there is no disclosure or suggestion regarding stress dispersibility.

### CITATION LIST

### Patent Literature

[PTL 1] JP 06-322168 A

[PTL 2] JP 2003-165860 A

### SUMMARY OF INVENTION

### Technical Problem

An object of the present invention is to provide a flame-retardant foam, which has high flame retardancy, is excellent in flexibility, and is excellent in stress dispersibility. Another object of the present invention is to provide a foam member including such flame-retardant foam as a flame-retardant foam layer.

### Solution to Problem

According to one embodiment of the present invention, there is provided a flame-retardant foam having an apparent density of from 0.02 g/cm³ to 0.40 g/cm³, a 50% compression load of from 0.5 N/cm² to 8.0 N/cm², and a rupture elongation in a tensile test of 120% or less.

In one embodiment, the flame-retardant foam has an average cell diameter of from 10 μm to 200 μm.

In one embodiment, the flame-retardant foam has a coefficient of variation in cell diameter of 0.5 or less.

In one embodiment, the flame-retardant foam has a cell ratio of 30% or more.

In one embodiment, the flame-retardant foam has a thickness of a cell wall of from 0.1 μm to 10 μm.

In one embodiment, the flame-retardant foam contains a flame retardant.

In one embodiment, the flame retardant includes a non-halogen-non-antimony-based flame retardant.

In one embodiment, the flame retardant has a bulk density of 0.8 g/cm³ or less.

In one embodiment, the flame-retardant foam has a residue at 650° C. of 20 wt % or more.

In one embodiment, a resin forming the flame-retardant foam is a polyolefin-based resin.

In one embodiment, the polyolefin-based resin is a mixture of polypropylene other than a polyolefin-based elastomer and the polyolefin-based elastomer.

According to another embodiment of the present invention, there is provided a foam member, including: the flame-retardant foam serving as a flame-retardant foam layer; and a pressure-sensitive adhesive layer on at least one side of the flame-retardant foam layer.

### Advantageous Effects of Invention

According to the present invention, the flame-retardant foam, which has high flame retardancy, is excellent in flexibility, and is excellent in stress dispersibility, can be provided. In addition, the foam member including such flame-retardant foam as a flame-retardant foam layer can be provided.

### BRIEF DESCRIPTION OF DRAWINGS

FIG. 1 is a schematic sectional view of a stress relaxation tester.

### DESCRIPTION OF EMBODIMENTS

<<<<1. Flame-Retardant Foam>>>>

A flame-retardant foam of the present invention has an apparent density of from 0.02 g/cm³ to 0.40 g/cm³, a 50% compression load of from 0.5 N/cm² to 8.0 N/cm², and a rupture elongation in a tensile test of 120% or less. The flame-retardant foam of the present invention has high flame retardancy, is excellent in flexibility, and is excellent in stress dispersibility because the apparent density, the 50% compression load, and the rupture elongation in a tensile test fall within the above-mentioned ranges.

The flame-retardant foam of the present invention has a cell structure. Examples of such cell structure include a closed-cell structure, an open-cell structure, and a semi-open and semi-closed-cell structure (cell structure in which a closed-cell structure and an open-cell structure are mixed). The cell structure of the flame-retardant foam of the present invention is preferably an open-cell structure or a semi-open and semi-closed-cell structure, more preferably a semi-open and semi-closed-cell structure from the viewpoint that the effects of the present invention can be further exhibited. When the cell structure of the flame-retardant foam of the present invention is a semi-open and semi-closed-cell structure, the ratio of a closed-cell structure therein is preferably 40% or less, more preferably 30% or less.

The closed-cell ratio of the flame-retardant foam of the present invention is obtained by, for example, submerging an object to be measured in water under an environment having a temperature of 23° C. and a humidity of 50%, measuring the mass of the object thereafter, then sufficiently drying the object in an oven at 80° C., and then measuring the mass of the resultant again. In addition, open cells can retain water, and hence the mass thereof can be measured to be obtained as open cells.

The flame-retardant foam of the present invention has an apparent density of from 0.02 g/cm³ to 0.40 g/cm³, preferably from 0.03 g/cm³ to 0.30 g/cm³, more preferably from 0.04 g/cm³ to 0.20 g/cm³, particularly preferably from 0.05 g/cm³ to 0.15 g/cm³, most preferably from 0.07 g/cm³ to 0.10 g/cm³. When the apparent density falls within the above-mentioned ranges, the flame-retardant foam of the present invention can have higher flame retardancy, can be more excellent in flexibility, and can be more excellent in stress dispersibility. A method of measuring the apparent density is described later in detail.

The flame-retardant foam of the present invention has a 50% compression load of from 0.5 N/cm² to 8.0 N/cm², preferably from 0.6 N/cm² to 6.0 N/cm², more preferably from 0.7 N/cm² to 5.5 N/cm², particularly preferably from 0.8 N/cm² to 5.0 N/cm², most preferably from 0.9 N/cm² to 4.5 N/cm². When the 50% compression load falls within the above-mentioned ranges, the flame-retardant foam of the present invention can have higher flame retardancy, can be more excellent in flexibility, and can be more excellent in stress dispersibility. A method of measuring the 50% compression load is described later in detail.

The flame-retardant foam of the present invention has a rupture elongation in a tensile test of 120% or less, preferably 110% or less, more preferably 105% or less, still more preferably 100% or less, particularly preferably 95% or less, most preferably 90% or less. In actuality, the lower limit of the rupture elongation in a tensile test of the flame-retardant foam of the present invention is preferably 1% or more, more preferably 5% or more, still more preferably 10% or more, particularly preferably 15% or more, most preferably 20% or more. When the rupture elongation in a tensile test falls within the above-mentioned ranges, the flame-retardant foam of the present invention can have higher flame retardancy, can be more excellent in flexibility, and can be more excellent in stress dispersibility. In the case where the rupture elongation in a tensile test is small, when a load is applied to the flame-retardant foam, the deformation of a cell wall of the flame-retardant foam becomes small. For example, when a filler is added, slippage is liable to occur at an interface between the resin forming the flame-retardant foam and the filler, and the load can be further relaxed. Meanwhile, when the rupture elongation in a tensile test is too large, the deformation of the cell wall of the flame-retardant foam becomes large, and there is a risk in that the load may not be easily relaxed. A method of measuring the rupture elongation in a tensile test is described later in detail.

The flame-retardant foam of the present invention has an average cell diameter of preferably from 10 μm to 200 μm, more preferably from 15 μm to 180 μm, still more preferably from 20 μm to 150 μm, particularly preferably from 23 μm to 120 μm, particularly preferably from 25 μm to 100 μm. When the average cell diameter falls within the above-mentioned ranges, the flame-retardant foam of the present invention can have higher flame retardancy, can be more excellent in flexibility, and can be more excellent in stress dispersibility. In addition, the flame-retardant foam of the present invention can be excellent also in compression recoverability, and further can return to the vicinity of the original thickness thereof within a short period of time after being subjected to an impact. Accordingly, the flame-retardant foam of the present invention can be more excellent in durability against repeated impacts. A method of measuring the average cell diameter is described later in detail.

The flame-retardant foam of the present invention has a coefficient of variation in cell diameter of preferably 0.5 or less, more preferably 0.48 or less, still more preferably 0.45 or less, particularly preferably 0.43 or less, most preferably 0.4 or less. In actuality, the lower limit of the coefficient of variation in cell diameter of the flame-retardant foam of the present invention is preferably 0.01 or more, more preferably 0.05 or more, still more preferably 0.1 or more, particularly preferably 0.15 or more, most preferably 0.2 or more. When the coefficient of variation in cell diameter falls within the above-mentioned ranges, the flame-retardant foam of the present invention can have higher flame retardancy, can be more excellent in flexibility, and can be more excellent in stress dispersibility. When the coefficient of variation in cell diameter is larger, a stress is concentrated more locally, and hence it is preferred that the coefficient of variation in cell diameter be small. A method of measuring the coefficient of variation in cell diameter is described later in detail.

The flame-retardant foam of the present invention has a cell ratio of preferably 30% or more, more preferably 50% or more, still more preferably 65% or more, yet still more preferably 75% or more, particularly preferably 80% or more, most preferably 90% or more. In actuality, the upper limit of the cell ratio is 99% or less. When the cell ratio falls within the above-mentioned ranges, the flame-retardant foam of the present invention can have higher flame retardancy, can be more excellent in flexibility, and can be more excellent in stress dispersibility. When the cell ratio is small, the repulsive stress when the flame-retardant foam is compressed becomes high, and there is a risk in that the device may be damaged when the flame-retardant foam is used by being inserted into a gap of the device. A method of measuring the cell ratio is described later in detail.

In the flame-retardant foam of the present invention, the thickness of a cell wall is preferably from 0.1 μm to 10 μm, more preferably from 0.3 μm to 8 μm, still more preferably from 0.5 μm to 5 μm, particularly preferably from 0.7 μm to 4 μm, most preferably from 1 μm to 3 μm. When the thickness of the cell wall falls within the above-mentioned ranges, the flame-retardant foam of the present invention can have higher flame retardancy, can be more excellent in flexibility, and can be more excellent in stress dispersibility. When the thickness of the cell wall is too thin, the flame-retardant foam is easily deformed with respect to a load, and there is a risk in that a sufficient load dispersion effect may not be obtained. When the thickness of the cell wall is too thick, the flame-retardant foam is not easily deformed with respect to a load, and there is a risk in that the step followability may be deteriorated when the flame-retardant foam is used in a gap of the device. A method of measuring the thickness of the cell wall is described later in detail.

The flame-retardant foam of the present invention has a residue at 650° C. of preferably 20 wt % or more, more preferably from 20 wt % to 80 wt %, still more preferably from 22 wt % to 70 wt %, particularly preferably from 26 wt % to 60 wt %, most preferably from 30 wt % to 50 wt %. A method of measuring the residue at 650° C. is described later in detail.

As the shape of the flame-retardant foam of the present invention, any appropriate shape may be adopted depending on the purpose. Such shape is typically a sheet shape, and in this case, the flame-retardant foam of the present invention may be treated as a flame-retardant foam layer.

When the flame-retardant foam of the present invention has a sheet shape (that is, in the case of a flame-retardant foam layer), the thickness thereof is preferably from 30 μm to 5,000 μm, more preferably from 35 μm to 4,000 μm, still more preferably from 40 μm to 3,000 μm, particularly preferably from 45 μm to 2,500 μm. When the thickness of the flame-retardant foam layer falls within the above-mentioned ranges, the flame-retardant foam layer can easily follow even a minute clearance. In addition, when the thickness of the flame-retardant foam layer falls within the above-mentioned ranges, the flame-retardant foam layer can contain cells in a uniform manner, and can exhibit excellent impact absorbability.

The flame-retardant foam of the present invention may be formed by any appropriate method to the extent that the effects of the present invention are not impaired. A typical example of such method is a method involving foaming a resin composition containing a resin material (polymer).

<<1-1. Resin Composition>>

The flame-retardant foam of the present invention may be typically obtained by foaming a resin composition. The resin composition contains a resin material (polymer).

As the resin material (polymer) contained in the resin composition, any appropriate resin material (polymer) may be adopted to the extent that the effects of the present invention are not impaired. Examples of such resin material (polymer) include an acrylic resin, a silicone-based resin, a urethane-based resin, a polyolefin-based resin, an ester-based resin, and a rubber-based resin. The number of kinds of such resin materials (polymers) may be only one, or two or more.

The content ratio of the resin material (polymer) in the resin composition is preferably from 30 wt % to 95 wt %, more preferably from 35 wt % to 90 wt %, still more preferably from 40 wt % to 80 wt %, particularly preferably from 40 wt % to 60 wt %. When the content ratio of the resin material (polymer) in the resin composition falls within the above-mentioned ranges, the flame-retardant foam of the present invention can have higher flame retardancy, can be more excellent in flexibility, and can be more excellent in stress dispersibility.

The resin material (polymer) contained in the resin composition is preferably a polyolefin-based resin from the viewpoint that the effects of the present invention can be further exhibited. The number of kinds of the polyolefin-based resins may be only one, or two or more.

The content ratio of the polyolefin-based resin in the resin material (polymer) contained in the resin composition is preferably from 50 wt % to 100 wt %, more preferably from 70 wt % to 100 wt %, still more preferably from 90 wt % to 100 wt %, particularly preferably from 95 wt % to 100 wt %, most preferably substantially 100 wt %.

As the polyolefin-based resin, there is given preferably at least one kind selected from the group consisting of a polyolefin and a polyolefin-based elastomer, more preferably a form in which a polyolefin and a polyolefin-based elastomer are used in combination.

When the polyolefin and the polyolefin-based elastomer are used in combination as the polyolefin-based resin, the content ratio of the polyolefin and the polyolefin-based elastomer (polyolefin/polyolefin-based elastomer) is preferably from 1/99 to 99/1, more preferably from 10/90 to 90/10, still more preferably from 20/80 to 80/20, particularly preferably from 30/70 to 70/30 in terms of weight ratio from the viewpoint that the effects of the present invention can be further exhibited.

The number of kinds of the polyolefins may be only one, or two or more.

The number of kinds of the polyolefin-based elastomers may be only one, or two or more.

As used herein, the term “polyolefin” does not encompass “polyolefin-based elastomer”.

As the polyolefin, any appropriate polyolefin may be adopted to the extent that the effects of the present invention are not impaired. Examples of such polyolefin include a linear polyolefin and a branched polyolefin (having a branched chain).

Such polyolefin is, for example, a polymer containing (formed of) an α-olefin as an essential monomer component, that is, a polymer having at least a structural unit derived from an α-olefin in the molecule (in one molecule). Such polyolefin may be, for example, a polymer containing only an α-olefin, or a polymer containing an α-olefin and a monomer component other than the α-olefin.

The polyolefin may be a homopolymer or a copolymer containing two or more kinds of monomers. When the polyolefin is a copolymer, any appropriate copolymerization form may be adopted as the copolymerization form thereof. Examples of such copolymerization form include a random copolymer and a block copolymer.

Preferred examples of the α-olefin, which may form the polyolefin, include α-olefins each having 2 to 8 carbon atoms (e.g., ethylene, propylene, 1-butene, 1-pentene, 1-hexene, 4-methyl-1-pentene, 1-heptene, and 1-octene). The number of kinds of the α-olefins, each of which may form the polyolefin, may be only one, or two or more.

Examples of the monomer component other than the α-olefin, which may form the polyolefin, include ethylenically unsaturated monomers, such as vinyl acetate, acrylic acid, an acrylic acid ester, methacrylic acid, a methacrylic acid ester, and vinyl alcohol. The number of kinds of the monomer components other than the α-olefin, each of which may form the polyolefin, may be only one, or two or more.

Specific examples of the polyolefin include low-density polyethylene, medium-density polyethylene, high-density polyethylene, linear low-density polyethylene, polypropylene (propylene homopolymer), a copolymer of ethylene and propylene, a copolymer of ethylene and an α-olefin other than ethylene, a copolymer of propylene and an α-olefin other than propylene, a copolymer of ethylene, propylene, and an α-olefin other than ethylene and propylene, and a copolymer of propylene and an ethylenically unsaturated monomer.

The polyolefin is preferably a polymer containing propylene as an essential monomer component (polypropylene-based polymer), that is, a polymer having at least a structural unit derived from propylene, from the viewpoint that the effects of the present invention can be further exhibited. Examples of such polypropylene-based polymer include polypropylene (propylene homopolymer), a copolymer of ethylene and propylene, and a copolymer of propylene and an α-olefin other than propylene, and the polypropylene-based polymer is preferably polypropylene (propylene homopolymer). The number of kinds of the polypropylene-based polymers may be only one, or two or more.

The melt flow rate (MFR) of the polyolefin at a temperature of 230° C. is preferably from 0.2 g/10 min to 10 g/10 min, more preferably from 0.25 g/10 min to 5 g/10 min, still more preferably from 0.3 g/10 min to 3 g/10 min, particularly preferably from 0.35 g/10 min to 1.5 g/10 min from the viewpoint that the effects of the present invention can be further exhibited. The melt flow rate (MFR) of the polyolefin at a temperature of 230° C. refers to an MFR measured at a temperature of 230° C. and a load of 2.16 kgf based on ISO 1133 (JIS-K-7210).

As the polyolefin, it is preferred to use two or more kinds of polyolefins having different melt flow rates (MFRs) at a temperature of 230° C. within the above-mentioned ranges from the viewpoint that the effects of the present invention can be further exhibited. In this case, a polyolefin having a melt flow rate (MFR) at a temperature of 230° C. of preferably 0.2 g/10 min or more and less than 0.7 g/10 min (more preferably from 0.2 g/10 min to 0.65 g/10 min) is used in combination with a polyolefin having a melt flow rate (MFR) at a temperature of 230° C. of preferably from 0.7 g/10 min to 10 g/10 min (more preferably from 0.7 g/10 min to 5 g/10 min, still more preferably from 0.7 g/10 min to 3 g/10 min, particularly preferably from 0.7 g/10 min to 1.5 g/10 min, most preferably from 0.7 g/10 min to 1.3 g/10 min).

When the two or more kinds of polyolefins having different melt flow rates (MFR) at a temperature of 230° C. within the above-mentioned ranges are used in combination as the polyolefin, for example, a content ratio between such a polyolefin that the above-mentioned melt flow rate (MFR) at a temperature of 230° C. is preferably 0.2 g/10 min or more and less than 0.7 g/10 min (more preferably from 0.2 g/10 min to 0.65 g/10 min) and such a polyolefin that the melt flow rate (MFR) at a temperature of 230° C. is preferably from 0.7 g/10 min to 10 g/10 min (more preferably from 0.7 g/10 min to 5 g/10 min, still more preferably from 0.7 g/10 min to 3 g/10 min, particularly preferably from 0.7 g/10 min to 1.5 g/10 min, most preferably from 0.7 g/10 min to 1.3 g/10 min) is preferably from 1/99 to 99/1, more preferably from 10/90 to 90/10, still more preferably from 20/80 to 80/20, particularly preferably from 30/70 to 70/30, most preferably from 40/60 to 60/40 in terms of weight ratio from the viewpoint that the effects of the present invention can be further exhibited.

A commercially available product may be used as the polyolefin. Examples thereof include “E110G” (manufactured by Prime Polymer Co., Ltd.), “EA9” (manufactured by Japan Polypropylene Corporation), “EA9FT” (manufactured by Japan Polypropylene Corporation), “E-185G” (manufactured by Prime Polymer Co., Ltd.), “WB140HMS” (manufactured by Borealis AG), and “WB135HMS” (manufactured by Borealis AG).

As the polyolefin-based elastomer, any appropriate polyolefin-based elastomer may be adopted to the extent that the effects of the present invention are not impaired. Examples of such polyolefin-based elastomer include: an ethylene-propylene copolymer, an ethylene-propylene-diene copolymer, an ethylene-vinyl acetate copolymer, polybutene, polyisobutylene, chlorinated polyethylene, and a so-called non-cross-linked thermoplastic olefin-based elastomer (TPO), such as an elastomer in which a polyolefin component and a rubber component are physically dispersed, or an elastomer having a structure in which a polyolefin component and a rubber component are microphase-separated; and a dynamically cross-linked thermoplastic olefin-based elastomer (TPV) that is a multiphase polymer which is obtained by dynamically heat-treating a mixture containing a resin component A (olefin-based resin component A) forming a matrix and a rubber component B forming a domain in the presence of a cross-liking agent and which has a sea-island structure in which cross-linked rubber particles are finely dispersed as a domain (island phase) in the resin component A that is a matrix (sea phase).

The polyolefin-based elastomer preferably contains a rubber component. Examples of such rubber component include those described in JP 08-302111 A, JP 2010-241934 A, JP 2008-024882 A, JP 2000-007858 A, JP 2006-052277 A, JP 2012-072306 A, JP 2012-057068 A, JP 2010-241897 A, JP 2009-067969 A, and JP 03/002654 A1.

Specific examples of the elastomer having a structure in which a polyolefin component and an olefin-based rubber component are microphase-separated include an elastomer formed of a polypropylene resin (PP) and an ethylene-propylene rubber (EPM) and an elastomer formed of a polypropylene resin (PP) and an ethylene-propylene-diene rubber (EPDM). The weight ratio between the polyolefin component and the olefin-based rubber component as the polyolefin component/olefin-based rubber is preferably from 90/10 to 10/90, more preferably from 80/20 to 20/80 from the viewpoint of compatibility.

The dynamically cross-linked thermoplastic olefin-based elastomer (TPV) generally has a higher modulus of elasticity and a smaller compression set as compared to the non-cross-linked thermoplastic olefin-based elastomer (TPO). As a result, the dynamically cross-linked thermoplastic olefin-based elastomer (TPV) has satisfactory recoverability, and can exhibit excellent recoverability when formed into a foam.

As described above, the dynamically cross-linked thermoplastic olefin-based elastomer (TPV) is a multiphase polymer which is obtained by dynamically heat-treating a mixture containing a resin component A (olefin-based resin component A) forming a matrix and a rubber component B forming a domain in the presence of a cross-liking agent, and which has a sea-island structure in which cross-linked rubber particles are finely dispersed as a domain (island phase) in the resin component A that is a matrix (sea phase).

Examples of the dynamically cross-linked thermoplastic olefin-based elastomer (TPV) include those described in JP 2000-007858 A, JP 2006-052277 A, JP 2012-072306 A, JP 2012-057068 A, JP 2010-241897 A, JP 2009-067969 A, and JP 03/002654 A1.

A commercially available product may be used as the dynamically cross-linked thermoplastic olefin-based elastomer (TPV). Examples thereof include “Zeotherm” (manufactured by Zeon Corporation), “THERMORUN” (manufactured by Mitsubishi Chemical Corporation), and “SARLINK 3245D” (manufactured by Toyobo Co., Ltd.).

The melt flow rate (MFR) of the polyolefin-based elastomer at a temperature of 230° C. is preferably from 2 g/10 min to 15 g/10 min, more preferably from 3 g/10 min to 10 g/10 min, still more preferably from 3.5 g/10 min to 9 g/10 min, particularly preferably from 4 g/10 min to 8 g/10 min, most preferably from 4.5 g/10 min to 7.5 g/10 min from the viewpoint that the effects of the present invention can be further exhibited. The melt flow rate (MFR) of the polyolefin-based elastomer at a temperature of 230° C. refers to an MFR measured at a temperature of 230° C. and a load of 2.16 kgf based on ISO 1133 (JIS-K-7210).

The melt tension (190° C., at the time of rupture) of the polyolefin-based elastomer is preferably less than 10 cN, more preferably from 5 cN to 9.5 cN from the viewpoint that the effects of the present invention can be further exhibited.

The JIS A hardness of the polyolefin-based elastomer is preferably from 30° to 95°, more preferably from 35° to 90°, still more preferably from 40° to 88°, particularly preferably from 45° to 85°, most preferably from 50° to 83° from the viewpoint that the effects of the present invention can be further exhibited. The JIS A hardness refers to hardness measured based on ISO 7619 (JIS K6253).

The resin composition preferably contains a flame retardant from the viewpoint that the effects of the present invention can be further exhibited. The number of kinds of the flame retardants that may be contained in the resin composition may be only one, or two or more.

The content ratio of the flame retardant in the resin composition is preferably from 10 wt % to 70 wt %, more preferably from 15 wt % to 65 wt %, still more preferably from 20 wt % to 60 wt %, particularly preferably from 40 wt % to 60 wt %. When the content ratio of the flame retardant in the resin composition falls within the above-mentioned ranges, the flame-retardant foam of the present invention can have higher flame retardancy, can be more excellent in flexibility, and can be more excellent in stress dispersibility.

Examples of the flame retardant that may be contained in the resin composition include a bromine-based flame retardant, a chlorine-based flame retardant, a phosphorus-based flame retardant, and an antimony-based flame retardant. However, the chlorine-based flame retardant and the bromine-based flame retardant generate gas components that are harmful to a human body and corrosive to devices during burning, and the phosphorus-based flame retardant and the antimony-based flame retardant have problems such as harmfulness and explodability. Accordingly, in the present invention, the non-halogen-non-antimony-based flame retardant is preferred as the flame retardant that may be contained in the resin composition.

The non-halogen-non-antimony-based flame retardant is a compound containing at least one kind selected from the group consisting of aluminum, magnesium, calcium, nickel, cobalt, tin, zinc, copper, iron, titanium, and boron from the viewpoint that the effects of the present invention can be further exhibited. Typical examples of such inorganic compound include hydrated metal compounds, such as aluminum hydroxide, magnesium hydroxide, a magnesium oxide/nickel oxide hydrate, and a magnesium oxide/zinc oxide hydrate. The hydrated metal compound may be subjected to surface treatment.

As the bulk density of the flame retardant that may be contained in the resin composition, any appropriate bulk density may be adopted to the extent that the effects of the present invention are not impaired. Such bulk density is preferably 0.8 g/cm³ or less, more preferably 0.6 g/cm³ or less, still more preferably 0.4 g/cm³ or less, particularly preferably 0.35 g/cm³ or less, most preferably 0.3 g/cm³ or less from the viewpoint that the effects of the present invention can be further exhibited. In actuality, the lower limit value of the bulk density is 0.01 g/cm³ or more, preferably 0.05 g/cm³ or more, more preferably 0.1 g/cm³ or more. When the bulk density of the flame retardant that may be contained in the resin composition falls within the above-mentioned ranges, sufficient flame retardancy can be imparted even when the usage amount of the flame retardant is small. When the usage amount of the flame retardant can be reduced, a flame-retardant foam that is flexible with a high foam expansion rate and is excellent in stress dispersibility can be obtained. In addition, when the bulk density of the flame retardant that may be contained in the resin composition is too high, there is a risk in that the dispersibility of the flame retardant in the resin composition may be deteriorated, and there is a risk in that the flame retardancy of the flame-retardant foam may be varied, and the appearance quality of the flame-retardant foam may be impaired.

As the particle diameter of the flame retardant that may be contained in the resin composition, any appropriate particle diameter may be adopted to the extent that the effects of the present invention are not impaired. Such particle diameter is preferably 5 μm or less, more preferably 3 μm or less, still more preferably 1 μm or less from the viewpoint that the effects of the present invention can be further exhibited. In actuality, the lower limit value of the particle diameter of the flame retardant that may be contained in the resin composition is 0.1 μm or more. When the particle diameter of the flame retardant that may be contained in the resin composition falls within the above-mentioned ranges, the dispersibility of the flame retardant in the resin composition can be improved. As a result, the flame retardancy of the flame-retardant foam can be uniformly exhibited, and the appearance quality of the flame-retardant foam can also be maintained. When the particle diameter of the flame retardant that may be contained in the resin composition is too large, there is a risk in that the dispersibility of the flame retardant in the resin composition may be deteriorated, and there is a risk in that the flame retardancy of the flame-retardant foam may be varied, and the appearance quality of the flame-retardant foam may be impaired. In addition, when the particle diameter of the flame retardant that may be contained in the resin composition is too large, there is a risk in that the load dispersibility of the flame-retardant foam may be decreased.

As the specific surface area of the flame retardant that may be contained in the resin composition, any appropriate specific surface area may be adopted to the extent that the effects of the present invention are not impaired. Such specific surface area is preferably 2 m²/g or more, more preferably 4 m²/g or more, still more preferably 6 m²/g or more from the viewpoint that the effects of the present invention can be further exhibited. In actuality, the upper limit value of the specific surface area of the flame retardant that may be contained in the resin composition is 20 m²/g or less. When the specific surface area of the flame retardant that may be contained in the resin composition falls within the above-mentioned ranges, the dispersibility of the flame retardant in the resin composition can be improved. As a result, the flame retardancy of the flame-retardant foam can be uniformly exhibited, and the appearance quality of the flame-retardant foam can also be maintained. When the specific surface area of the flame retardant that may be contained in the resin composition is too large, there is a risk in that the dispersibility of the flame retardant in the resin composition may be deteriorated, and there is a risk in that the flame retardancy of the flame-retardant foam may be varied, and the appearance quality of the flame-retardant foam may be impaired. In addition, when the specific surface area of the flame retardant that may be contained in the resin composition is too high, the load dispersibility of the flame-retardant foam may be decreased.

The flame retardant that may be contained in the resin composition may be subjected to surface treatment. As such surface treatment, any appropriate surface treatment may be adopted to the extent that the effects of the present invention are not impaired. Examples of such surface treatment include silane coupling treatment and stearic acid treatment.

The resin composition may contain any appropriate other components to the extent that the effects of the present invention are not impaired. The number of kinds of such other components may be only one, or two or more. Examples of such other component include a rubber, a resin other than the polymer blended as the resin material, a softening agent, an aliphatic compound, an age resistor, an antioxidant, a light stabilizer, a weathering agent, a UV absorber, a dispersant, a plasticizer, carbon, an antistatic agent, a surfactant, a cross-linking agent, a thickener, a rust preventive, a silicone-based compound, a tension modifier, an anti-shrinkage agent, a fluidity modifier, a gelling agent, a curing agent, a filler, a reinforcing agent, a foaming agent, a foam nucleating agent, a colorant (e.g., a pigment or a dye), a pH adjustor, a solvent (organic solvent), a thermal polymerization initiator, a photopolymerization initiator, a lubricant, a crystal nucleating agent, a crystallization accelerator, a vulcanizing agent, a surface treatment agent, and a dispersing aid.

<<1-2. Formation of Flame-Retardant Foam>>

The flame-retardant foam of the present invention is typically obtained by foaming a resin composition. A method to be generally used for foam forming, such as a physical method or a chemical method, may be adopted as a foaming method (method of forming cells). That is, the flame-retardant foam of the present invention may be typically a foam formed through foaming by a physical method (physical foam), or may be a foam formed through foaming by a chemical method (chemical foam). The physical method generally involves dispersing a gas component, such as air or nitrogen, in a polymer solution, and forming cells through mechanical mixing (mechanical foam). The chemical method is generally a method involving forming cells with a gas produced by the pyrolysis of a foaming agent added to a polymer base, to thereby obtain a foam.

The resin composition to be subjected to foam forming may be prepared by mixing constituent components through use of any appropriate means, for example, any appropriate melt-kneading apparatus, such as an open-type mixing roll, a closed-type Banbury mixer, a single-screw extruder, a twin-screw extruder, a continuous kneader, or a pressurizing kneader.

<First Embodiment for Forming Flame-Retardant Foam of the Present Invention>

As a first embodiment for forming the flame-retardant foam of the present invention, there is given, for example, a mode of forming a flame-retardant foam through a step of mechanically foaming an emulsion resin composition (emulsion containing the resin material (polymer) and the like) to produce cells (step A). As a foaming apparatus, there are given, for example, an apparatus of a high-speed shearing system, an apparatus of a vibration system, and an apparatus of a pressurized gas-ejecting system. Of those foaming apparatus, an apparatus of a high-speed shearing system is preferred from the viewpoints of a reduction in cell diameter and large-volume production. The first embodiment for forming the flame-retardant foam of the present invention is applicable to formation from any resin composition.

The solid content concentration of the emulsion is preferably as high as possible from the viewpoint of film formability. The solid content concentration of the emulsion is preferably 30 wt % or more, more preferably 40 wt % or more, still more preferably 50 wt % or more.

A cell when the resin composition is foamed by mechanical stirring is such that a gas is taken in an emulsion. Any appropriate gas may be adopted as the gas as long as the gas is inert to the emulsion to the extent that the effects of the present invention are not impaired. Examples of such gas include air, nitrogen, and carbon dioxide.

The flame-retardant foam of the present invention may be obtained through a step of applying the emulsion resin composition (bubble-containing emulsion resin composition) foamed by the above-mentioned method onto a base material, followed by drying (step B). Examples of the base material include a release-treated plastic film (e.g., a release-treated polyethylene terephthalate film) and a plastic film (e.g., a polyethylene terephthalate film).

Any appropriate methods may be adopted as an application method and a drying method in the step B to the extent that the effects of the present invention are not impaired. The step B preferably includes: a preliminary drying step B1 of drying the bubble-containing emulsion resin composition applied onto the base material at 50° C. or more and less than 125° C.; and a main drying step B2 of further drying the composition at 125° C. or more and 200° C. or less after the preliminary drying.

The provision of the preliminary drying step B1 and the main drying step B2 can prevent the coalescence of cells and the rupture of the cells due to an abrupt temperature increase. Particularly in a foam sheet having a small thickness, the significance of the provision of the preliminary drying step B1 is large because the cells coalesce or rupture owing to an abrupt temperature increase. The temperature in the preliminary drying step B1 is preferably from 50° C. to 100° C. A time period for the preliminary drying step B1 is preferably from 0.5 minute to 30 minutes, more preferably from 1 minute to 15 minutes. The temperature in the main drying step B2 is preferably from 130° C. to 180° C. or less, more preferably from 130° C. to 160° C. A time period for the main drying step B2 is preferably from 0.5 minute to 30 minutes, more preferably from 1 minute to 15 minutes.

<Second Embodiment for Forming Flame-Retardant Foam of the Present Invention>

As a second embodiment for forming the flame-retardant foam of the present invention, there is given a mode of forming a foam by foaming a resin composition with a foaming agent. A foaming agent to be generally used for foam forming may be used as the foaming agent, and a high-pressure inert gas is preferably used from the viewpoints of environmental protection and a low property of contaminating the object to be foamed.

Any appropriate inert gas may be adopted as the inert gas as long as the gas is inert to, and can impregnate, the resin composition. Examples of such inert gas include carbon dioxide, a nitrogen gas, and air. Those gases may be used as a mixture. Of those, carbon dioxide is preferred from the viewpoint of impregnating the resin material (polymer) with a large amount and at a high rate.

The inert gas is preferably in a supercritical state. That is, carbon dioxide in a supercritical state is particularly preferably used. In the supercritical state, the solubility of the inert gas into the resin composition further increases. Consequently, the inert gas can be mixed at a high concentration into the composition, and besides, the inert gas has a high concentration at the time of an abrupt pressure reduction. Accordingly, the frequency of occurrence of cell nuclei increases, and the density of cells to be produced by the growth of the cell nuclei becomes larger than in any other state even with the same porosity. Thus, fine cells can be obtained. Carbon dioxide has a critical temperature of 31° C. and a critical pressure of 7.4 MPa.

As a method of forming a foam by impregnating the resin composition with the high-pressure inert gas, there is given, for example, a method of forming a foam through: a gas-impregnating step of impregnating the resin composition containing the resin material (polymer) with the inert gas under high pressure; a decompressing step of reducing the pressure after the gas-impregnating step to foam the resin material (polymer); and as required, a heating step of growing cells by heating. In this case, an unfoamed formed body that has been formed in advance may be impregnated with the inert gas, or a resin composition that has been melted may be impregnated with the inert gas under a pressurized state and then subjected to forming at the time of the decompression. Those steps may be performed by any of a batch system and a continuous system. That is, the steps may be performed by a batch system involving forming the resin composition into an appropriate shape, such as a sheet shape, to provide an unfoamed resin formed body in advance, then impregnating the unfoamed resin formed body with the high-pressure gas, and releasing the pressure of the gas to foam the formed body, or may be performed by a continuous system involving kneading the resin composition together with the high-pressure gas under increased pressure, and forming the kneaded product, and at the same time, releasing the pressure to simultaneously perform the forming and foaming of the kneaded product.

An example in which the foam is produced by the batch system is described below. For example, the resin composition is extruded with an extruder, such as a single-screw extruder or a twin-screw extruder, to thereby produce a resin sheet for foam forming. Alternatively, the resin composition is uniformly kneaded with a kneader including a blade of, for example, a roller-, cam-, kneader-, or Banbury-type, and the kneaded product is subjected to press processing into a predetermined thickness with, for example, a hot-plate press, to thereby produce an unfoamed resin formed body. The thus obtained unfoamed resin formed body is placed in a pressure vessel, and the high-pressure inert gas (e.g., carbon dioxide in a supercritical state) is injected to impregnate the unfoamed resin formed body with the inert gas. At the time point when the unfoamed resin formed body is sufficiently impregnated with the inert gas, the pressure is released (to typically atmospheric pressure) to produce cell nuclei in the resin. The cell nuclei may be directly grown at room temperature, but may be grown by being heated in some cases. A known or commonly used method, such as a water bath, an oil bath, a heat roll, a hot-air oven, a far-infrared ray, a near-infrared ray, or a microwave, may be adopted as a method for the heating. After cells have been thus grown, their shapes are fixed by abrupt cooling with, for example, cold water. Thus, the foam may be obtained. The unfoamed resin formed body to be subjected to foaming is not limited to a sheet-shaped product, and unfoamed resin formed bodies having various shapes may be used depending on applications. In addition, the unfoamed resin formed body to be subjected to foaming may be produced by any other forming method, such as injection molding, as well as extrusion molding or press forming.

An example in which the foam is produced by the continuous system is described below. For example, foam forming is performed by: a kneading and impregnating step of injecting (introducing) a high-pressure gas (in particular, an inert gas, more preferably carbon dioxide) while kneading the resin composition with an extruder, such as a single-screw extruder or a twin-screw extruder, to sufficiently impregnate the resin composition with the high-pressure gas; and a forming and decompressing step of extruding the resin composition through a die or the like arranged at the tip of the extruder to release the pressure (to typically atmospheric pressure), thereby simultaneously performing the forming and foaming of the composition. In addition, in the foam forming by the continuous system, a heating step of growing cells by heating may be provided as required. After the cells have been thus grown, their shapes may be fixed by abrupt cooling with, for example, cold water as required. In addition, the introduction of the high-pressure gas may be continuously performed, or may be discontinuously performed. Further, in the kneading and impregnating step and the forming and decompressing step, for example, an extruder or an injection molding machine may be used. A heating method at the time of the growth of cell nuclei is, for example, any appropriate method, such as a water bath, an oil bath, a heat roll, a hot-air oven, a far-infrared ray, a near-infrared ray, or a microwave. Any appropriate shape may be adopted as the shape of the foam. Examples of such shape include a sheet shape, a prism shape, a cylindrical shape, and a heteromorphic shape.

The mixing amount of the gas at the time of the foam forming of the resin composition is, for example, preferably from 2 wt % to 10 wt %, more preferably from 2.5 wt % to 8 wt %, still more preferably from 3 wt % to 6 wt % with respect to the total amount of the resin composition because a highly foamed foam can be obtained.

The pressure at the time of the impregnation of the resin composition with the inert gas may be appropriately selected in consideration of operability or the like. Such pressure is, for example, preferably 6 MPa or more (e.g., from 6 MPa to 100 MPa), more preferably 8 MPa or more (e.g., from 8 MPa to 50 MPa). The pressure in the case of using carbon dioxide in a supercritical state is preferably 7.4 MPa or more from the viewpoint of retaining the supercritical state of carbon dioxide. When the pressure is less than 6 MPa, cell growth at the time of the foaming is remarkable, and hence the cell diameter becomes so large that a preferred average cell diameter cannot be obtained in some cases. This is because of the following reason. When the pressure is low, the impregnation amount of the gas becomes relatively small as compared to that at the time of a high pressure, and hence a cell nucleus formation rate is reduced to decrease the number of cell nuclei to be formed. Accordingly, the amount of the gas per one cell is inversely increased, and hence the cell diameter becomes excessively large. In addition, in a pressure region of less than 6 MPa, even when the impregnation pressure is changed to a small extent, the cell diameter and a cell density are changed to a large extent, and hence the cell diameter and the cell density are liable to become difficult to control.

The temperature in the gas-impregnating step varies depending on, for example, the kinds of the inert gas to be used and components in the resin composition, and may be selected from a wide range. When operability or the like is taken into consideration, the temperature is preferably from 10° C. to 350° C. The impregnation temperature in the case of impregnating the unfoamed formed body with the inert gas by the batch system is preferably from 10° C. to 250° C., more preferably from 40° C. to 230° C. In addition, the impregnation temperature in the case of extruding a molten polymer impregnated with the gas to simultaneously perform the foaming and forming of the polymer by the continuous system is preferably from 60° C. to 350° C. When carbon dioxide is used as the inert gas, the temperature at the time of the impregnation is preferably 32° C. or more, more preferably 40° C. or more in order to retain the supercritical state of the gas.

In the decompressing step, a decompression rate is preferably from 5 MPa/sec to 300 MPa/sec in order to obtain uniform and fine cells.

A heating temperature in the heating step is preferably from 40° C. to 250° C., more preferably from 60° C. to 250° C.

<<<<2. Foam Member>>>>

A foam member of the present invention includes: the above-mentioned flame-retardant foam of the present invention serving as a flame-retardant foam layer; and a pressure-sensitive adhesive layer on at least one side of the flame-retardant foam layer.

The thickness of the flame-retardant foam layer included in the foam member of the present invention is preferably from 30 μm to 5,000 μm, more preferably from 35 μm to 4,000 μm, still more preferably from 40 μm to 3,000 μm, particularly preferably from 45 μm to 2,500 μm. When the thickness of the flame-retardant foam layer falls within the above-mentioned ranges, the flame-retardant foam layer can easily follow even a minute clearance. In addition, when the thickness of the flame-retardant foam layer falls within the above-mentioned ranges, the flame-retardant foam layer can contain cells in a uniform manner, and can exhibit excellent impact absorbability.

The thickness of the pressure-sensitive adhesive layer is preferably from 5 μm to 300 μm, more preferably from 6 μm to 200 μm, still more preferably from 7 μm to 100 μm, particularly preferably from 8 μm to 50 μm. When the thickness of the pressure-sensitive adhesive layer falls within the above-mentioned ranges, the foam member of the present invention can exhibit excellent impact absorbability.

As the pressure-sensitive adhesive layer, a layer formed of any appropriate pressure-sensitive adhesive may be adopted. Examples of the pressure-sensitive adhesive forming the pressure-sensitive adhesive layer include a rubber-based pressure-sensitive adhesive (e.g., a synthetic rubber-based pressure-sensitive adhesive or a natural rubber-based pressure-sensitive adhesive), a urethane-based pressure-sensitive adhesive, an acrylic urethane-based pressure-sensitive adhesive, an acrylic pressure-sensitive adhesive, a silicone-based pressure-sensitive adhesive, a polyester-based pressure-sensitive adhesive, a polyamide-based pressure-sensitive adhesive, an epoxy-based pressure-sensitive adhesive, a vinyl alkyl ether-based pressure-sensitive adhesive, a fluorine-based pressure-sensitive adhesive, and a rubber-based pressure-sensitive adhesive. The pressure-sensitive adhesive forming the pressure-sensitive adhesive layer is preferably at least one kind selected from an acrylic pressure-sensitive adhesive, a silicone-based pressure-sensitive adhesive, and a rubber-based pressure-sensitive adhesive. The number of kinds of such pressure-sensitive adhesives may be only one, or two or more. The number of the pressure-sensitive adhesive layers may be one, or two or more.

When the pressure-sensitive adhesives are classified in terms of pressure-sensitive adhesive form, examples thereof include an emulsion-type pressure-sensitive adhesive, a solvent-type pressure-sensitive adhesive, an ultraviolet cross-linking-type (UV cross-linking-type) pressure-sensitive adhesive, an electron beam cross-linking-type (EB cross-linking-type) pressure-sensitive adhesive, and a hot melt-type pressure-sensitive adhesive. The number of kinds of such pressure-sensitive adhesives may be only one, or two or more.

The water vapor transmission rate of the pressure-sensitive adhesive layer is preferably 50 (g/(m²·24 hours)) or less, more preferably 30 (g/(m²·24 hours)) or less, still more preferably 20 (g/(m²·24 hours)) or less, particularly preferably 10 (g/(m²·24 hours)) or less. When the water vapor transmission rate of the pressure-sensitive adhesive layer falls within the above-mentioned ranges, the impact absorbability of the foam sheet of the present invention can be stabilized without being influenced by water.

The pressure-sensitive adhesive forming the pressure-sensitive adhesive layer may contain any appropriate other components to the extent that the effects of the present invention are not impaired.

Examples of the other component include any other polymer component, a softening agent, an age resistor, a curing agent, a plasticizer, a filler, an antioxidant, a thermal polymerization initiator, a photopolymerization initiator, a UV absorber, a light stabilizer, a colorant (e.g., a pigment or a dye), a solvent (organic solvent), a surfactant (e.g., an ionic surfactant, a silicone-based surfactant, or a fluorine-based surfactant), and a cross-linking agent (e.g., a polyisocyanate-based cross-linking agent, a silicone-based crosslinking agent, an epoxy-based cross-linking agent, or an alkyl etherified melamine-based cross-linking agent). The thermal polymerization initiator and the photopolymerization initiator may be contained in the material for forming the polymer component.

The foam member of the present invention may be produced by any appropriate method. The foam member of the present invention may be produced by, for example, a method involving laminating the flame-retardant foam layer and the pressure-sensitive adhesive layer, or a method involving laminating a material for forming the pressure-sensitive adhesive layer and the flame-retardant foam layer, and then forming the pressure-sensitive adhesive layer through a curing reaction or the like.

### EXAMPLES

Now, the present invention is described specifically by way of Examples. However, the present invention is by no means limited to these Examples. Test and evaluation methods in Examples and the like are as described below. The term “part(s)” in the following description means “part(s) by weight” unless otherwise specified, and the term “%” in the following description means “wt %” unless otherwise specified.

<Method of Measuring Apparent Density>

The density (apparent density) of the flame-retardant foam was calculated as described below. A resin foam structure obtained in each of Examples and Comparative Examples was punched into a size of 20 mm×20 mm to form a test piece, and the dimensions of the test piece were measured with a caliper. Next, the weight of the test piece was measured with an electronic balance. Then, the apparent density was calculated by the following expression.

Apparent density (g/cm³)=weight of test piece/volume of test piece

<Method of Measuring 50% Compression Load>

The measurement was performed in accordance with a method of measuring compression hardness of a foam described in JIS K 6767. Specifically, a stress (N) when the resin foam structure obtained in each of Examples and Comparative Examples was cut out into a size of 30 mm×30 mm to form a test piece and the test piece was compressed at a compression speed of 10 mm/min until a compression ratio of 50% was achieved was converted per unit area (1 cm²) to provide a 50% compression load (N/cm²).

<Method of Measuring Rupture Elongation in Tensile Test>

The measurement was performed in accordance with a method of measuring rupture elongation of a foam described in JIS K 6767.

<Methods of Measuring Average Cell Diameter and Coefficient of Variation in Cell Diameter>

An enlarged image of a cell portion of the resin foam structure obtained in each of Examples and Comparative Examples was captured through use of a digital microscope (product name: “VEX-500”, manufactured by Keyence Corporation) as a measuring instrument, and the image was analyzed through use of analysis software of the measuring instrument, to thereby obtain an average cell diameter (μm). The number of cells in the captured enlarged image was about 400. In addition, the standard deviation was calculated from all the cell diameter data, and the coefficient of variation was calculated through use of the following expression.

Coefficient of variation=standard deviation/average cell diameter

<Method of Measuring Cell Ratio>

The measurement was performed under an environment having a temperature of 23° C. and a humidity of 50%. The resin foam structure obtained in each of Examples and Comparative Examples was punched with a punching blade die measuring 100 mm by 100 mm, and the dimensions of the punched sample were measured. In addition, the thickness of the sample was measured with a 1/100 dial gauge having a measuring terminal with a diameter (φ) of 20 mm. The volume of the resin foam structure obtained in each of Examples and Comparative Examples was calculated from those values. Next, the weight of the resin foam structure obtained in each of Examples and Comparative Examples was measured with an even balance having a minimum scale of 0.01 g or more. The cell ratio of the resin foam structure obtained in each of Examples and Comparative Examples was calculated from those values.

<Method of Measuring Thickness of Cell Wall>

An enlarged image of a cell portion of the resin foam structure obtained in each of Examples and Comparative Examples was captured through use of a digital microscope (product name: “VEX-500”, manufactured by Keyence Corporation) as a measuring instrument, and the image was analyzed through use of analysis software of the measuring instrument, to thereby obtain a thickness (μm) of a cell wall. The number of cells in the captured enlarged image was about 400.

<Method of Measuring Residue of Flame-Retardant Foam at 650° C.>

5 mg of the resin foam structure obtained in each of Examples and Comparative Examples was placed in a platinum container, and the temperature was raised under a nitrogen gas atmosphere within a measurement range of from 25° C. to 680° C. at a rate of temperature increase of 20° C./min. The residue at 650° C. was measured through use of TG/DTA6200 (manufactured by SII Nano Technology Inc.).

<Method of Measuring Horizontal Burning Distance>

The measurement was performed in accordance with a flame-retardant test method for a foam described in UL94. When the horizontal burning distance is smaller, the flame retardancy tends to be excellent.

<Method of Measuring Degree of Stress Dispersion>

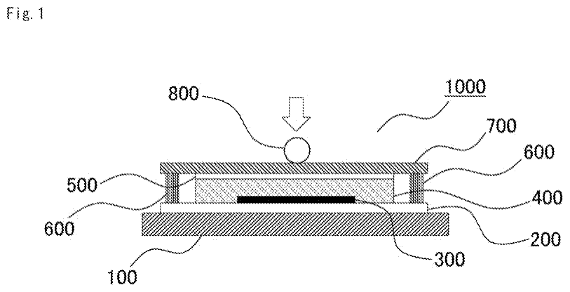

FIG. 1 is a schematic sectional view of a stress relaxation tester 1000 to be used for measuring a degree of stress dispersion.

As illustrated in FIG. 1, a polycarbonate plate (200 mm×300 mm×1 mm (thickness)) 200 was placed on an iron support 100, and a stress measurement film 300 (product name: “Prescale” (two sheets for extreme low pressure (4LW)), manufactured by Fujifilm Corporation, sheet having a surface on which a pressurized portion develops color, 50 mm×50 mm×0.16 mm (thickness)) was placed on the polycarbonate plate 200. Next, the resin foam structure (150 mm×200 mm×0.5 mm (thickness)) 400 obtained in each of Examples and Comparative Examples to be measured was placed on the stress measurement film 300, and a double-sided adhesive tape (No. 5603, manufactured by Nitto Denko Corporation, thickness: 0.03 mm) 500 was bonded to the resin foam structure 400. Then, a spacer 600 having a thickness of 0.3 mm was arranged, and an ABS plate (200 mm×300 mm×3 mm (thickness)) 700 was placed in an uppermost portion. An iron ball (φ25 mm) 800 was placed in a center portion from above the ABS plate 700, to thereby apply a load of 100 N for 1 min.

After that, a change in color of the stress measurement film 300 was observed. The case in which the color did not spread from the center of the stress measurement film 300 and became a dot shape was evaluated as C. The case in which the color spread from the center of the stress measurement film 300 to 25 mm was evaluated as B. The case in which the color spread widely from the center of the stress measurement film 300 to an end portion of 50 mm was evaluated as A.

### Example 1

32.5 Parts by weight of polypropylene [melt flow rate (MFR) (230° C.): 0.40 g/10 min], 32.5 parts by weight of polypropylene [melt flow rate (MFR) (230° C.): 1.1 g/10 min], 35 parts by weight of a polyolefin-based elastomer [product name: “Thermorun 5850N”, manufactured by Mitsubishi Chemical Corporation], 120 parts by weight of magnesium hydroxide (product name: “MGZ-1”, manufactured by Sakai Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (1) having a thickness of 2.2 mm.

In the resin foam structure (1), the apparent density was 0.07 g/cm³, the 50% compression load was 4.0 N/cm², and the rupture elongation was 89%.

The results are shown in Table 1.

### Example 2

32.5 Parts by weight of polypropylene [melt flow rate (MFR) (230° C.): 0.40 g/10 min], 32.5 parts by weight of polypropylene [melt flow rate (MFR) (230° C.): 1.1 g/10 min], 35 parts by weight of a polyolefin-based elastomer [product name: “Milastomer 8030N”, manufactured by Mitsui Chemicals, Inc.], 120 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (2) having a thickness of 2.2 mm.

In the resin foam structure (2), the apparent density was 0.07 g/cm³, the 50% compression load was 3.5 N/cm², and the rupture elongation was 77%.

The results are shown in Table 1.

### Example 3

19 Parts by weight of polypropylene [melt flow rate (MFR) (230° C.): 0.40 g/10 min], 19 parts by weight of polypropylene [melt flow rate (MFR) (230° C.): 1.1 g/10 min], 67 parts by weight of a polyolefin-based elastomer [product name: “Milastomer 8030N”, manufactured by Mitsui Chemicals, Inc.], 80 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (3) having a thickness of 1.8 mm.

In the resin foam structure (3), the apparent density was 0.07 g/cm³, the 50% compression load was 1.7 N/cm², and the rupture elongation was 90%.

The results are shown in Table 1.

### Example 4

16.5 Parts by weight of polypropylene [melt flow rate (MFR) (230° C.): 0.40 g/10 min], 16.5 parts by weight of polypropylene [melt flow rate (MFR) (230° C.): 1.1 g/10 min], 67 parts by weight of a polyolefin-based elastomer [product name: “Milastomer 8030N”, manufactured by Mitsui Chemicals, Inc.], 60 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (4) having a thickness of 1.8 mm.

In the resin foam structure (4), the apparent density was 0.085 g/cm³, the 50% compression load was 2.1 N/cm², and the rupture elongation was 85%.

The results are shown in Table 1.

### Example 5

20.5 Parts by weight of polypropylene [melt flow rate (MFR) (230° C.): 0.40 g/10 min], 20.5 parts by weight of polypropylene [melt flow rate (MFR) (230° C.): 1.1 g/10 min], 59 parts by weight of a polyolefin-based elastomer [product name: “Milastomer 8030N”, manufactured by Mitsui Chemicals, Inc.], 60 parts by weight of magnesium hydroxide (product name: “KISUMA 5P”, manufactured by Kyowa Chemical Industry Co., Ltd.), 100 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (5) having a thickness of 1.8 mm.

In the resin foam structure (5), the apparent density was 0.085 g/cm³, the 50% compression load was 2.9 N/cm², and the rupture elongation was 80%.

The results are shown in Table 1.

### Comparative Example 1

16.5 Parts by weight of polypropylene [melt flow rate (MFR) (230° C.): 0.40 g/10 min], 16.5 parts by weight of polypropylene [melt flow rate (MFR) (230° C.): 1.1 g/10 min], 67 parts by weight of a polyolefin-based elastomer [product name: “Thermorun 5850N”, manufactured by Mitsubishi Chemical Corporation], 40 parts by weight of magnesium hydroxide (product name: “KISUMA 5P”, manufactured by Kyowa Chemical Industry Co., Ltd.), 10 parts by weight of carbon (product name: “Asahi #35”, manufactured by Asahi Carbon Co., Ltd.), and 1 part by weight of monoglyceride stearate were kneaded at a temperature of 200° C. with a twin-screw kneader manufactured by The Japan Steel Works, Ltd. (JSW). After that, the resultant was extruded into a strand shape and cooled with water, and then molded into a pellet shape. The pellet was loaded into a single-screw extruder manufactured by The Japan Steel Works, Ltd., and a carbon dioxide gas was injected at a pressure of 13 (12 after injection) MPa under a 220° C. atmosphere. The carbon dioxide gas was injected at a ratio of 3 parts by weight with respect to 100 parts by weight of the resin. After the carbon dioxide gas was sufficiently saturated, the resultant was cooled to a temperature suitable for foaming and extruded from a die to provide a sheet-shaped resin foam structure (C1) having a thickness of 1.8 mm.

In the resin foam structure (C1), the apparent density was 0.065 g/cm³, the 50% compression load was 1.8 N/cm², and the rupture elongation was 140%.

The results are shown in Table 1.

### Comparative Example 2

The foam containing polyurethane as a main component was defined as a resin foam structure (C2).

In the resin foam structure (C2), the apparent density was 0.40 g/cm³, the 50% compression load was 12 N/cm², and the rupture elongation was 130%.

The results are shown in Table 1.

### Comparative Example 3

50 Parts by weight of polypropylene [density: 0.9 g/cm³, melt flow rate (MFR) (230° C.): 4 g/10 min], 50 parts by weight of an olefin-based elastomer [product name: “Milastomer 8030N”, manufactured by Mitsui Chemicals, Inc.], 10 parts by weight of carbon black produced by an oil furnace method, and 100 parts by weight of a composite metal hydroxide having a polyhedral shape represented by the formula: MgO.NiO.H₂O (average particle diameter: 0.7 μm) were kneaded at a temperature of 180° C. with Labo Plastomill (manufactured by Toyo Seiki Seisaku-sho, Ltd.) equipped with roller-shaped wings. After that, the resultant was molded into a sheet shape of φ80 mm having a thickness of 0.5 mm through use of a hot plate press heated to 180° C. This sheet was placed in a pressure-resistant container and kept under a 150° C. atmosphere at a pressure of 15 MPa for 10 minutes to impregnate the sheet with carbon dioxide. Then, the pressure was abruptly reduced to provide a resin foam structure (C3).

In the resin foam structure (C3), the apparent density was 0.033 g/cm³, the 50% compression load was 2.49 N/cm², and the rupture elongation was 140%.

The results are shown in Table 1.

### Comparative Example 4

100 Parts by weight of an acrylic emulsion solution (solid content: 55%, ethyl acrylate-butyl acrylate-acrylonitrile copolymer (45:48:7 in terms of weight ratio of a monomer used), 2 parts by weight of a fatty acid ammonium-based surfactant (water dispersion of ammonium stearate, solid content: 33%) (surfactant A), 2 parts by weight of a carboxybetaine-type amphoteric surfactant (“AMOGEN CB-H”, manufactured by DKS Co., Ltd.) (surfactant B), 4 parts by weight of an oxazoline-based cross-linking agent (“EPOCROS WS-500”, manufactured by Nippon Shokubai Co., Ltd., solid content: 39%), and 1 part by weight of a pigment (carbon black) (“NAF-5091”, manufactured by Dainichiseika Color & Chemicals Mfg. Co., Ltd.) were stirred and mixed with a disper (“ROBOMIX”, manufactured by Primix Corporation) to be foamed. The foam composition was applied onto a release-treated polyethylene terephthalate (PET) film (thickness: 38 μm, product name: “MRF #38”, manufactured by Mitsubishi Plastics, Inc.), and was dried at 70° C. for 4.5 minutes and at 140° C. for 4.5 minutes to provide a resin foam structure (C4) (thickness: 0.20 mm)

In the resin foam structure (C4), the apparent density was 0.70 g/cm³, the 50% compression load was 7.2 N/cm², and the rupture elongation was 100%.

The results are shown in Table 1.

### Comparative Example 5

100 Parts by weight of an acrylic emulsion solution (solid content: 55%, ethyl acrylate-butyl acrylate-acrylonitrile copolymer (45:48:7 in terms of weight ratio of a monomer used), 1.6 parts by weight of a fatty acid ammonium-based surfactant (water dispersion of ammonium stearate, solid content: 33%) (surfactant A), 1.6 parts by weight of a carboxybetaine-type amphoteric surfactant (“AMOGEN CB-H”, manufactured by DKS Co., Ltd.) (surfactant B), 4 parts by weight of an oxazoline-based cross-linking agent (“EPOCROS WS-500”, manufactured by Nippon Shokubai Co., Ltd., solid content: 39%), 2 parts by weight of a pigment (carbon black) (“NAF-5091”, manufactured by Dainichiseika Color & Chemicals Mfg. Co., Ltd.), 0.8 part by weight of a polyacrylic acid-based thickener (ethyl acrylate-acrylic acid copolymer (20 wt % of acrylic acid in terms of content ratio of a monomer used), solid content: 28.7%), and 25 parts by weight of surface-treated silica particles (“Nipsil E150J”, manufactured by Tosoh Silica Corporation) were stirred and mixed with a disper (“ROBOMIX”, manufactured by Primix Corporation) to be foamed. The foam composition was applied onto a release-treated polyethylene terephthalate (PET) film (thickness: 38 μm, product name: “MRF #38”, manufactured by Mitsubishi Plastics, Inc.), and was dried at 70° C. for 4.5 minutes and at 140° C. for 4.5 minutes to provide a resin foam structure (C5) (thickness: 0.20 mm)

In the resin foam structure (C5), the apparent density was 0.30 g/cm³, the 50% compression load was 11 N/cm², and the rupture elongation was 80%.

The results are shown in Table 1.

TABLE 1

| | Example | Example | Example | Example | Example | Comparative | Comparative | Comparative | Comparative | Comparative |
|---|---|---|---|---|---|---|---|---|---|---|
| | 1 | 2 | 3 | 4 | 5 | Example 1 | Example 2 | Example 3 | Example 4 | Example 5 |
| Apparent | 0.07 | 0.07 | 0.07 | 0.085 | 0.085 | 0.065 | 0.4 | 0.033 | 0.7 | 0.3 |
| density | | | | | | | | | | |
| (g/cm³) | | | | | | | | | | |
| 50% | 4 | 3.5 | 1.7 | 2.1 | 2.9 | 1.8 | 12 | 2.49 | 7.2 | 11 |
| compression | | | | | | | | | | |
| load (N/cm²) | | | | | | | | | | |
| Rupture | 89 | 77 | 90 | 85 | 80 | 140 | 130 | 140 | 100 | 80 |
| elongation (%) | | | | | | | | | | |
| Average cell | 80 | 85 | 80 | 75 | 75 | 80 | 50 | 80 | 60 | 60 |
| diameter (μm) | | | | | | | | | | |
| Coefficient of | 0.33 | 0.3 | 0.35 | 0.39 | 0.33 | 0.45 | 0.6 | 0.5 | 0.5 | 0.45 |
| variation in | | | | | | | | | | |
| cell diameter | | | | | | | | | | |
| Cell ratio (%) | 95 | 95 | 95 | 94 | 94 | 95 | 60 | 97 | 40 | 70 |
| Thickness of | 2 | 1.5 | 1.4 | 1.5 | 1.5 | 1.5 | 10 | 1 | 2 | 2 |
| cell wall (μm) | | | | | | | | | | |
| Bulk density | 0.39 | 0.26 | 0.26 | 0.26 | 0.26 | 0.26 | 0.4 | 0.6 | 0.6 | 0.6 |
| of flame | | | | | | | | | | |
| retardant | | | | | | | | | | |
| (g/cm³) | | | | | | | | | | |
| Residue at | 40 | 39 | 34 | 32 | 36 | 25 | 15 | 18 | 5 | 20 |
| 650° C. (wt %) | | | | | | | | | | |
| Horizontal | 50 | 50 | 80 | 100 | 60 | 140 | 80 | 50 | 150 | 150 |
| burning | | | | | | | | | | |
| distance (mm) | | | | | | | | | | |
| Degree of | A | A | A | A | A | B | C | C | B | B |
| stress | | | | | | | | | | |
| dispersion | | | | | | | | | | |

### Production Example 1

A reaction vessel with a stirrer, a temperature gauge, a nitrogen gas inlet tube, a reflux condenser, and a dropping funnel was loaded with 60 parts of butyl acrylate (BA), 40 parts of 2-ethylhexyl acrylate (2EHA), and 5 parts of acrylic acid (AA) serving as monomer components, and 135 parts of toluene serving as a polymerization solvent, and while a nitrogen gas was introduced, the contents were stirred for 2 hours. After oxygen in the polymerization system had been thus removed, 0.1 part of azobisisobutyronitrile (AIBN) serving as a polymerization initiator was added, and solution polymerization was performed at 60° C. for 6 hours to provide a toluene solution of an acrylic polymer. The Mw of the acrylic polymer was 40×10⁴.

30 Parts of a polymerized rosin ester (product name: “PENSEL D-125”, softening point: 120° C. to 130° C., manufactured by Arakawa Chemical Industries, Ltd.) serving as a tackifying resin and 2 parts of an isocyanate-based cross-linking agent (product name: “CORONATE L”, manufactured by Tosoh Corporation, solid content: 75%) were added with respect to 100 parts of the acrylic polymer contained in the toluene solution to prepare an acrylic pressure-sensitive adhesive composition. The acrylic pressure-sensitive adhesive composition was applied onto a release-treated polyethylene terephthalate (PET) film (thickness: 38 μm, product name: “MRF #38”, manufactured by Mitsubishi Plastics, Inc.), and was dried at 120° C. for 5 minutes to provide a pressure-sensitive adhesive layer (1) having a thickness of 30 μm.

### Example 6

The pressure-sensitive adhesive layer (1) obtained in Production Example 1 was bonded to one side of the resin foam structure (1) obtained in Example 1 to provide a foam member (1) having a two-layer structure of resin foam structure (1)/pressure-sensitive adhesive layer (1).

### Example 7

The pressure-sensitive adhesive layer (1) obtained in Production Example 1 was bonded to each of both sides of the resin foam structure (1) obtained in Example 1 to provide a foam member (2) having a three-layer structure of pressure-sensitive adhesive layer (1)/resin foam structure (1)/pressure-sensitive adhesive layer (1).

### INDUSTRIAL APPLICABILITY

The flame-retardant foam of the present invention can be suitably applied, for example, as a flame-retardant foam for an electronic device.

### REFERENCE SIGNS LIST

1000 stress relaxation tester

100 iron support

200 polycarbonate plate

300 stress measurement film

400 resin foam structure

500 double-sided adhesive tape

600 spacer

700 ABS plate

800 iron ball

1. A flame-retardant foam having an apparent density of from 0.02 g/cm³ to 0.40 g/cm³, a 50% compression load of from 0.5 N/cm² to 8.0 N/cm², and a rupture elongation in a tensile test of 120% or less.

2. The flame-retardant foam according to claim 1, wherein the flame-retardant foam has an average cell diameter of from 10 μm to 200 μm.

3. The flame-retardant foam according to claim 1, wherein the flame-retardant foam has a coefficient of variation in cell diameter of 0.5 or less.

4. The flame-retardant foam according to claim 1, wherein the flame-retardant foam has a cell ratio of 30% or more.

5. The flame-retardant foam according to claim 1, wherein the flame-retardant foam has a thickness of a cell wall of from 0.1 μm to 10 μm.

6. The flame-retardant foam according to claim 1, wherein the flame-retardant foam contains a flame retardant.

7. The flame-retardant foam according to claim 6, wherein the flame retardant includes a non-halogen-non-antimony-based flame retardant.

8. The flame-retardant foam according to claim 6, wherein the flame retardant has a bulk density of 0.8 g/cm³ or less.

9. The flame-retardant foam according to claim 1, wherein the flame-retardant foam has a residue at 650° C. of 20 wt % or more.

10. The flame-retardant foam according to claim 1, wherein a resin forming the flame-retardant foam is a polyolefin-based resin.

11. The flame-retardant foam according to claim 10, wherein the polyolefin-based resin is a mixture of polypropylene other than a polyolefin-based elastomer and the polyolefin-based elastomer.

12. A foam member, comprising:
the flame-retardant foam of claim 1 serving as a flame-retardant foam layer; and
a pressure-sensitive adhesive layer on at least one side of the flame-retardant foam layer.
